(19) United States
(12) Patent Application Publication
(10) Pub. No.: US 2008/0196916 A1
(43) Pub. Date: Aug. 21, 2008

(54) Electrically Conductive Chain

(76) Inventor: Hubert Juillet, Willer sur Thur (FR)

Correspondence Address: BACON AND THOMAS, 625 SLATER LANE, 4TH FLOOR, ALEXANDRIA, VA, 22314, US

(21) Appl. No.: 11/574,870

(22) PCT Filed: Oct. 3, 2005
(86) PCT No.: PCT/FR2005/002425

§ 371 Date: Apr. 2, 2007

(30) Foreign Application Priority Data
Oct. 6, 2004 (FR) 0410560

(51) Int. Cl. H01R 3/00; H01R 43/00

(52) U.S. Cl. 174/1; 29/825

(57) ABSTRACT

The invention concerns a novel type of electrical conductor made up of a string of beads (10). The conductor is isothermal. An inventive manufacturing method enables said string to be produced from a bulk aggregate of beads (1) which are subjected to a difference of electric potential via two electrodes (3, 4). The invention concerns electrotechnical and electronic industries.

The present invention has the object of new industrial product, a type of high performance electrical conductor.

It is already known,

All sorts of materials composed of elements or molecules which conduct electricity and of which the most predominant is copper.

The usual configuration of electric conductors is that of a wire.

It is known as well

The materials which are electric insulators at room temperature and which become electric conductors when submitted to low temperatures. Certain of these materials thus lose all electrical resistance, provided, however, not to exceed a threshold of intensity of the electrical current.

It is known as well

Another means of transporting electricity over a distance and which consists of converting the electric current in electromagnetic waves for transport, then to reconvert to electricity at arrival, the photovoltaic and the microwaves fall into this category.

Finally, one knows as well

Powders, notably of metal, which are electrical insulators in rest mass and become conducting when they are irradiated by an electromagnetic wave, the Branly coherer is an application of this phenomenon.

Various inventors have tried to perfect this coherer for the purpose of augmenting electric conduction. Yet other authors have tried to build a theory of radioconductors by modeling the coherer by a pile of balls one on another in a dielectric tube, then by compressing these balls in the tube with the aid of two mobile electrodes placed at each extremity of the tube. They then observed a very small increase in the conduction when one compressed the balls. Until today, no satisfactory explanation has been advanced by physicists for explaining radio conductivity. One generally agrees that a welding between grains or balls occurs permitting thereby the passage of electric current.

The different means of transporting electric energy presents disadvantages, among them.
the difficulty of transporting electric current over a long distance, due to the internal resistance R of the conductors.
the impossibility of transmitting an electric current in a thermal isolator.

The present invention aims, in particular, to overcome these inconveniences and refers to a system and an original process of electric conduction.

The invention is comprised of which the below description, as well as the attached drawings refer, and of which:

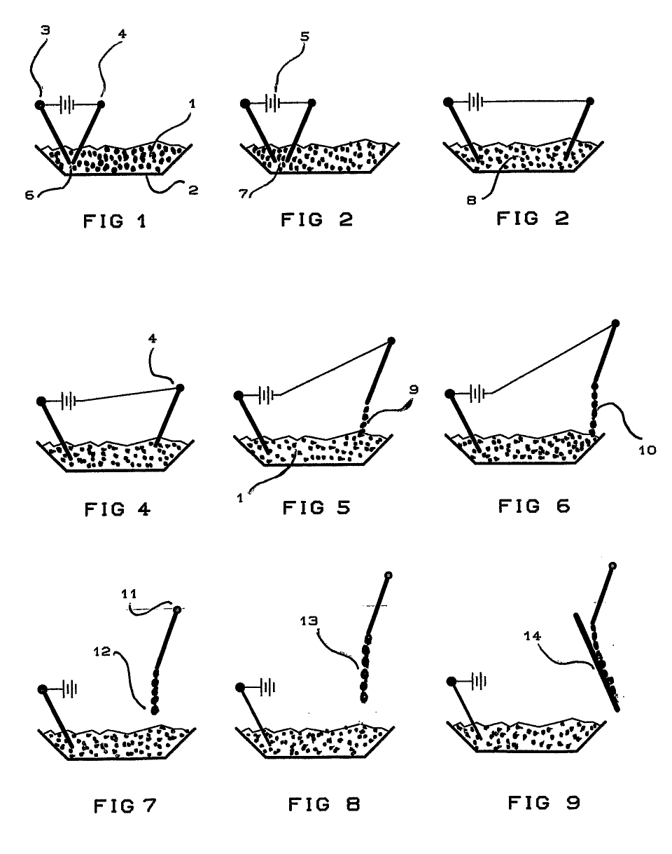

FIG. 1) is a cross sectional view of the first stage of fabrication of the said conductor.

FIGS. 2) to 9) are cross sectional views representing the stages of manufacturing the conductor.

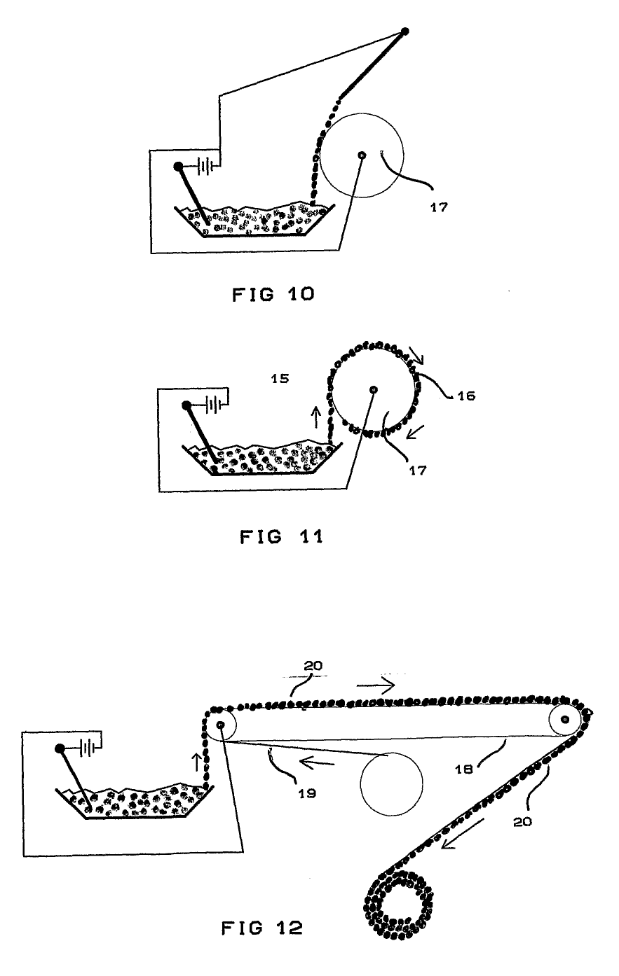

FIGS. 10) and 11) are cross sectional views representing a variant for manufacturing of the said conductor.

FIG. 12) is a cross sectional view representing another variant for manufacturing the said conductor.

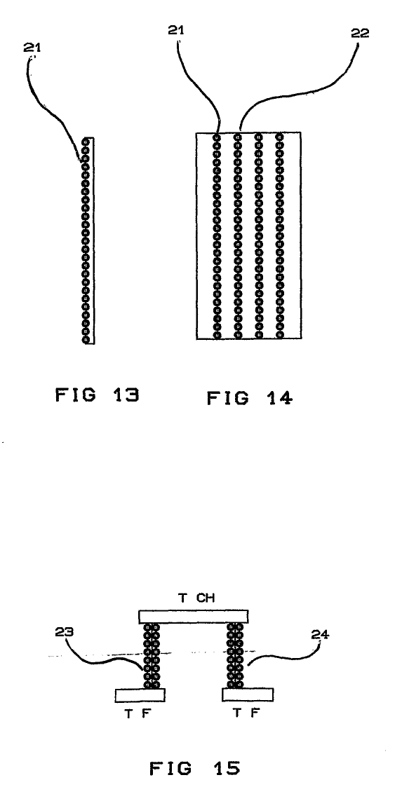

FIGS. 13) and 14) represent said conductors disposed on a support.

FIG. 15) represents a thermocouple made from the said conductors.

Further, the present system and process permits the transport of electric current over a distance by a material which is originally dielectric and isothermic and which becomes electrically conductive without being rendered a thermal conductor, by the effects of geometry and appropriate electrical charges carried by said material during its assembly, which process is new and original

The said material is a powder.

The said powder is laid out in a mass.

The said mass is dielectric.

The said mass is isothermic.

The said powder is constituted of grains.

The said grains are elongated and thin

The said grains are of metal.

The said process comprises a means permitting the transformation of the said mass into an electrical conductor.

The said process comprises in addition a means permitting the transformation of the said mass into an isothermic electrical conductor.

The said process and the said means consists of transforming the said mass in a chain of grains adhering on to another by an immaterial force

The said process and the said means yet consists of transporting the said mass in a chain of grains adhering one to another at their ends that are appreciably the most distant.

The said adhesion is realized by an immaterial force.

The said process comprises in addition a means permitting to induce the immaterial force.

The said procedure comprises in addition the means permitting to induce the said material force by immaterial means.

The said different means consist of disposing a mass of metallic grains (1) in a dielectric receptacle (2) and of inserting in the said mass two electrodes (3) and (4).

The said electrodes are then subjected to a difference in electric voltage by a connection to a source of electric current (5).

In a first period of time, the two electrodes are in contact with each other (6) below the surface of the said mass.

Then, one moves (7)(8) one of the said electrodes (4) away from the other (3), then one lifts one of the electrodes (4).

When the extremity of this electrode (4) exits the said mass (1), a chain (9) (10) is formed at the said extremity.

When this chain attains a desired length, one unplugs the electrode (4), which ends the process of lengthening the said chain (12) (13).

The chain remains suspended to the electrode, and then is placed on a support (14).

In a variant, one creates the said chain (15) in a continuous manner by roiling (16) the chain onto a mandrel (17), the latter being connected to the said source of energy (5).

For starting a chain in an assembly of this variant, one first proceeds manually as above, but instead of placing the chain on a support, one places it on the said mandrel (17).

Another variant of the present method consist of placing the said chain on a conveyor belt (18).

On may also unroll a film (19) on said belt until the chain (20) attached itself to it, and sticks there, this film then being rolled.

Many chains may be attached in this manner one next to the other (21) (22).

The items (23) and (24) represent the arms of a thermocouple made with said chains.

The conductor made accordingly provides new technical effects as follow:

If is configured as a chain of grains disposed one next to the other,

the said grains are in contact respectively by their most distant ends,

these grains are maintained amongst themselves merely by the immaterial force,

the said immaterial force is an attractive force,

the attractive force is an elastic force,

the said chain is home to an immaterial force during its assembly

it holds a residual immaterial force after its development,

The said residual force holds the grains together

The said chain is self-maintained and does not needs a support, a substrate, or a sheath to maintain.

The chain is flexible, it may be warped and can follow different paths without it coming apart,

After a short circuit between the two extremities of the said chain, the said force remains inducted and the said chain does not come apart,

The said chain possesses thermoelectric powers through use of grains made of appropriate material,

The said chain is substantially isothermal,

The said isothermal character is anisotropic,

The said isothermal anisotropic character has effect substantially in the longitudinal direction of the said chain,

The said chain is an electrical conductor

The said characteristic of conduction is anisotropic,

The said chain is an electrical conductor which offers only a very small resistance R to the conduction of electricity,

The said chairs is an electrical conductor which does not offer resistance R to the conduction of the electricity, depending on the nature of the grains used.

The present invention has a number of advantages, including:

The ability to transport electric current over a distance with conductors of a smaller cross section and with less loss, compared with conductors actually in use,

The ability to conduct electricity in an isothermal conductor, which permits, notably, their use for the development of thermocouple arms.

The ability to induce a more powerful magnetic field in a solenoid developed with the said conductor.

At a scientific level, the conductive chain demonstrates that, in a Branly coherer, the electrical conduction is not due to the creation of welds in a percolation and that the electrical current may freely circulate by other effects. The welds, when they appear, are the result of an earlier induced electrical conduction and they are therefore the result and not the cause of the said conduction.

Likewise, at the scientific level, the conductive chains, when processed using grains of a mesoscopic dimension, offers properties and behaviors approaching or identical to those of quantum wires, that is to say, 1D wires.

Quantum wires are produced by crystal growth or by technologies resulting from those used in the fabrication of integrated circuits, which implies the presence of a substrate or in the case of superconduction, of a ribbon.

A quantum wire on a substrate does not behave in the same way as a bare quantum wire.

The conductive chain avoids this limitation, because it does not need any support element like a substrate, a ribbon or a sheath.

Still further on a scientific level, the conductive chain sheds new light on the notion of “collective wave” and more precisely on the phonon and the plasmon. The observation of anisotropy between the direction of displacement of free electrons relative to phonons has never been observed before the invention of conductive chains and thus constitutes a new investigative tool for physics in general.

The present invention is not limited to the modes of execution described above or to the attached drawings which constitute only one among a number of modes of execution of the said invention. Thus:

The said receptacle containing the said mass may be subjected to vibrations for the purpose of assembling the said chain.

The said receptacle may be of differing configurations from those represented, it may be longitudinal, in the form of a “V”, horizontal, inclined, subjected to a centrifugal force or to all sorts of forces, vibrations of displacements.

The said chain may be assembled in the interior of a solenoid.

The said chain may be assembled in the interior of a solenoid powered by an alternating electric current.

The frequency of the said alternating current is adapted so as to permit the levitation of the said chain in the said solenoid, in a Meissner effect or by the magnetic moment of the spin of the atoms.

The said chain in the said solenoid may be powered with an alternating of pulsating electrical current.

The said alternating or pulsing current may be in opposite phase relative to the phase of the current that supplies the said solenoid.

The said mass may be brought to any temperatures during the assembly of the said chains.

One of the other said electrodes may be subjected to vibrations before or after assembly of the said chains to improve their development.

The said receptacle, the said chain, and the said electrodes may be subjected, together or separately, to a magnetic field in order to facilitate the assembly or to improve the characteristics of the said chains.

The parameters of the electric current applied to the said electrodes may have all sorts of values and may he optimized in function of the nature of the grains used, it may involve continuous DC current, pulsed current, inversed current, modulated current, alternating current of either low frequency, average frequency, high frequency, or very high frequencies.

One is able to develop the said chains in the presence of electromagnetic waves of all sorts, and in particular, micro-waves.

One of the electrodes may be made up of a receptacle itself, the latter being made of an electrically conductive material.

The grains used for the said chain may be of an infinite variety, made of all sorts of elementary bodies, of a mix of elementary bodies, of molecules of all sorts, organic, biological or mineral, of oxides, of sulfurs, and all sorts of halogens, of conductive materials, of insulators, of semi-conductors, and of crystal. The grains may exhibit very diverse characteristics, notably thermoelectric.

The grains may be made of radio elements, of congealed liquids, of congealed gas.

The grains may be made of porous material, or fibrous material, or laminar material.

The grains may take on an infinite number of geometric forms.

The grains may be of different natures in the said receptacle, creating in this way chains composed of different types of grains.

On is able to use the said chains by subjecting them to electromagnetic waves in order to modify their behavior.

One is able to use the said chains and subject them to physical waves like sounds and ultrasound in order to modify their behavior

One is able to use the said chains by submitting them to a heat or cold in order to modify their behavior.

One is able to use the said chains by subjecting them to different pressures, in particular, a gas or a liquid, in order to modify their behavior.

One is able to use the said chains by subjecting them to a vacuum, in order to modify their behavior.

One is able to use the said chains by subjecting them to a centrifugal force, or an acceleration, or deceleration, in order to modify their behavior.

One is able to use the said chains for introducing DC current, pulsing current, modulated current, or alternating currant having all sorts of frequencies.

One is able to use the said chains by subjecting them to all sorts of different actions for obtaining all sorts of results.

1. A method for the fabrication of an electrical conductor wherein the method comprises a combination of at least the following steps:
two electrodes are placed in contact in a mass of grains
applying an electric current to said two electrodes,
moving the electrodes apart in the said mass, one from the other, under electrical current,
moving away apart within the said mass one of the said electrodes from the other of said electrodes, thereby causing the formation of a chain of grains which bind one to another and which rest suspended between the said electrodes and the mass,
cutting the said electric current, which promotes detachment of the chain from the said mass,
placing the said chain which remains attached to the said electrode on a support.

2. An electrically conductive system characterized:
in that the said system comprises a device permitting the transformation of a material which is a mass of isothermal and dielectric grains into a chain of grains that are conductive of electricity.

3. The system of claim 2, further wherein means for inducing an immaterial force are formed by geometric effects and by appropriate electrical charge effects carried on the said material during its assembly.

4. The system of claim 2, further wherein said immaterial force is created by an electric current provided to the said electrodes and of the electrodes placement in the said mass.

5. The system of claim 2, further wherein the said grains (9) which are disposed one next to another, do not undergo mechanical compression.

6. The system of claim 2, further wherein the said grains adhere one to the other by the immaterial force.

7. The system of claim 2, further wherein the said grains contact one another substantially by their most distant end.

8. The system of claim 2, further wherein the immaterial force is an attractive force.

9. The system of claim 2, further wherein the attractive force is an elastic force.

10. The system of claim 2, further wherein the said force is residual.

11. The system of claim 2, further wherein the said chain is self-maintained and does not need a support, a substrate or a sheath.

12. The system of claim 2, further wherein the chain is appreciably a thermal insulator.

13. The system of claim 2, further wherein the isothermal character is substantially anisotropic.

14. The system of claim 2, further wherein the said chain may be warped and can follow different paths without it coming apart.

15. The system of claim 2, further wherein after said current is turned off at two extremities of the said chain, said chain does not disaggregate.

16. The system of claim 2, further wherein after having short circuited the two extremities of the chain, said chain does not disaggregate.

17. The system of claim 2, further wherein the said chain is an electric conductor having no resistance R to the conduction of electricity.

18. The system of claim 2, further wherein the said chain is an electric conductor having very little resistance R to the conduction of electricity.

19. The system of claim 2, applied in a process for making electrical conductors.

20. The system of claim 2, applied in a process for making thermocouples.
